(19) United States
(12) Patent Application Publication
(10) Pub. No.: US 2009/0207441 A1
(43) Pub. Date: Aug. 20, 2009

(54) Job Processing Apparatus and Method for Controlling the Job Processing Apparatus

(75) Inventor: Satoshi KOTAKA, Azumino-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/368,872

(22) Filed: Feb. 10, 2009

(30) Foreign Application Priority Data
Feb. 14, 2008 (JP) 2008-033112

(51) Int. Cl. G06F 3/12

(52) U.S. Cl. 358/1.15

(57) ABSTRACT

A job processing apparatus includes a first job-receiving section that receives a panel operation job produced by operating a control panel in a mode, and a second job-receiving section that receives non-panel operation jobs other than the panel operation job. A control panel mode-identifying section is also provided to identify which mode the control panel is in when the second job-receiving section receives any one of the non-panel operation jobs. A non-panel operation job-identifying section identifies which non-panel operation job has been received by the second job-receiving section. An execution timing control section controls when the non-panel operation job received by the non-panel operation job-receiving section is executed, according to the identified non-panel operation job and the identified mode of the control panel.

### BACKGROUND

1. Technical Field

The present invention relates to job processing apparatus and methods for controlling the job processing apparatus, and particularly to a job processing apparatus capable of processing a job produced by panel operation and a job produced by factors other than the panel operation and a method for controlling the job processing apparatus.

2. Related Art

For example, Japanese Unexamined Patent Application Publication No. 2006-42220 discloses a multifunction peripheral including a printer, a copy machine, and a facsimile in one body. Such a multifunction peripheral executes jobs according to operations of a control panel, such as inputting a direction to scan, copy, or fax an image or a document in front of the multifunction peripheral. The multifunction peripheral can receive a job from an external device connected to the multifunction peripheral through a network, such as a remote computer or a facsimile, and execute the job. In the following description, jobs produced by user's directly inputting a direction through a control panel are referred to as panel operation jobs, and other jobs are referred to as non-panel operation jobs.

Multifunction peripherals capable of receiving panel operation jobs and non-panel operation jobs appropriately prioritize these jobs and, thus, control when the jobs are started. In order to give precedence to user's panel operation, in general, a timer is started as a panel operation or a panel operation job is completed, and a non-panel operation job is executed after a lapse of a predetermined delay time. Thus, the multifunction peripheral prevents the inconvenience of executing a job transmitted from an external remote device to a user in front of the multifunction peripheral who operates the panel (Japanese Patent Application No. 2007-099451). In this instance, the predetermined time or delay time can be arbitrarily set, and may be in the range of, for example, 5 seconds to 3 minutes.

Even if a panel operation should take precedence, however, a non-panel operation job may be permitted to run immediately without conflicting for the same hardware resource with the panel operation, depending on the mode of panel operation (which operation is being performed) and the type of the non-panel operation job.

Such a case can arise in any job processing apparatus executing both panel operation jobs and non-panel operation jobs as well as in the multifunction peripheral.

### SUMMARY

An advantage of some aspects of the invention is that it provides a job processing apparatus that appropriately controls when non-panel operation jobs are executed, according to the type of the non-panel operation job and the mode of the control panel. More specifically, the job processing apparatus immediately executes non-panel operation jobs without interrupting user's panel operation unless a conflict for the same hardware resource arises.

According to an aspect of the invention, a job processing apparatus is provided. In the job processing apparatus, a first job-receiving section receives a panel operation job produced by operating a control panel in a mode, and a second job-receiving section receives non-panel operation jobs other than the panel operation job. A control panel mode-identifying section identifies which mode the control panel is in when the second section receives any one of the non-panel operation jobs. A non-panel operation job-identifying section identifies which non-panel operation job has been received by the second job-receiving section. An execution timing control section controls when the non-panel operation job received by the second job-receiving section is executed, according to the identified non-panel operation job and the identified mode of the control panel.

The job processing apparatus may further include at least one hardware resource used for executing the panel operation job and the non-panel operation jobs. If the identified non-panel operation job does not conflict with the identified mode of the control panel for the same hardware resource, the execution timing control section may control the received non-panel operation job so as to be executed immediately.

If the identified non-panel operation job conflicts with the identified mode of the control panel for the same hardware resource, the execution timing control section may control the received non-panel operation job so as not to be executed until a predetermined operation delay time elapses after the completion of the panel operation.

In this instance, the execution timing control section may place the non-panel operation job conflicting for the same hardware resource into a queue and executes the job in the queue after a lapse of a predetermined operation delay time.

Alternatively, the execution timing control section may refuse to execute the non-panel operation job conflicting for the same hardware resource.

The hardware resource may include a scanner. If the identified non-panel operation job and the identified mode of the control panel conflict with each other for the scanner, the execution timing control section may refuse to execute the non-panel operation job conflicting for the scanner.

The hardware resource may include a printing engine. If the identified non-panel operation job and the identified mode of the control panel conflict with each other for the printing engine, the execution timing control section may place the non-panel operation job conflicting for the printing engine into a queue and executes the job in the queue after a lapse of a predetermined operation delay time. The hardware resource may include a scanner that includes a document plate and a plurality of automatic document feeders, each automatically feeding a document onto the document plate. If the identified non-panel operation job and the identified mode of the control panel conflict with each other for the scanner, the execution timing control section may place the non-panel operation job conflicting for the scanner into a queue and executes the job in the queue after a lapse of a predetermined operation delay time.

According to another aspect of the invention, a method for controlling a job processing apparatus is provided. The method includes receiving a panel operation job produced by operating a control panel and receiving a non-panel operation job produced by non-panel operations other than the panel operation job. It is identified which mode the control panel is in when one of the non-panel operation jobs is received. It is also identified which non-panel operation job has been received. Furthermore, when the received non-panel operation job is executed is controlled according to the identified non-panel operation job and the identified mode of the control panel.

### BRIEF DESCRIPTION OF THE DRAWINGS

The invention will be described with reference to the accompanying drawings, wherein like numbers reference like elements.

FIG. 1 is a block diagram of the entire configuration of a job processing system according to a first embodiment of the invention.

FIG. 2 is a block diagram of the internal configuration of a multifunction peripheral of the system shown in FIG. 1.

FIG. 3 is a job control table held in the multifunction peripheral shown in FIG. 2 according to a first embodiment.

FIG. 4 is a flow chart of a panel operation-requested job control performed by the multifunction peripheral shown in FIG. 2.

FIG. 5 is a flow chart of a non-panel operation-requested job control performed by the multifunction peripheral shown in FIG. 2.

FIG. 6 is a block diagram of the internal configuration of a scanner of a multifunction peripheral according to a second embodiment and a third embodiment of the invention.

FIG. 7 is a job control table held in the multifunction peripheral shown in FIG. 2 according to the second embodiment.

FIG. 8 is a job control table held in the multifunction peripheral shown in FIG. 2 according to the third embodiment.

### DESCRIPTION OF EXEMPLARY EMBODIMENTS

Embodiments of the invention will now be described with reference to the drawings. However, the invention is not limited to the embodiments disclosed below.

### First Embodiment

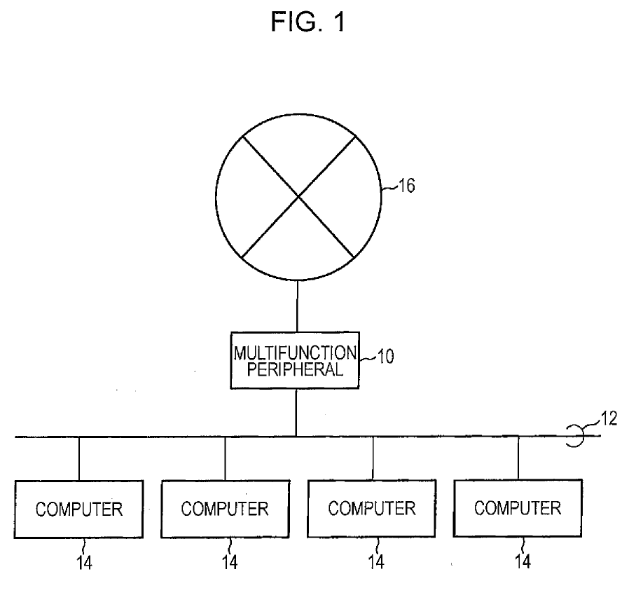

FIG. 1 is a block diagram of the entire configuration of a job processing system according to a first embodiment of the invention. As shown in FIG. 1, the job processing system of the first embodiment includes a multifunction peripheral 10 and at least one computer 14 connected to the multifunction peripheral 10 through a network 12.

The multifunction peripheral 10 of the present embodiment functions as a printer and a facsimile. The network 12 is a so-called local area network and can be configured with Ethernet (registered trademark). In addition to the computer 14, the job processing system may include other external apparatuses, such as a facsimile.

The multifunction peripheral 10 is connected to a fax network 16 through which the multifunction peripheral 10 can receive documents from other facsimiles and can send documents to other facsimiles.

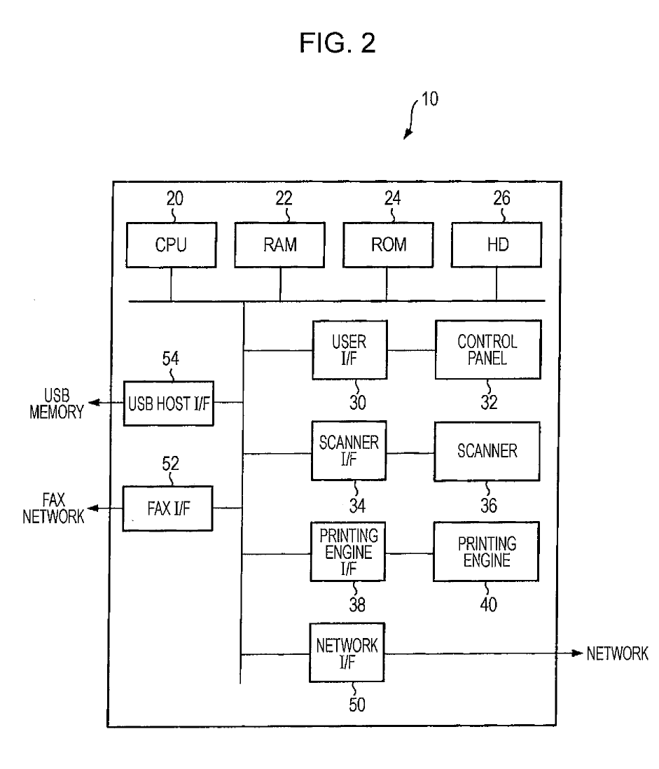

FIG. 2 is a block diagram of the internal configuration of the multifunction peripheral 10. As shown in FIG. 2, the multifunction peripheral 10 of the present embodiment includes a central processing unit (CPU) 20, a random access memory (RAM) 22, a read only memory (ROM) 24, and a hard disk drive (HD) 26, and these devices are connected to each other through an internal bus.

The CPU 20 reads various programs stored in the ROM 24 or the hard disk drive 26 and executes the programs to control the multifunction peripheral 10 in various ways. In addition, the CPU 20 temporarily stores data in the RAM 22 while programs are executed. Thus, the CPU 20 acts as a controller; the RAM 22 acts as a volatile memory; the ROM 24 acts as a nonvolatile memory; and the hard disk drive 26 acts as an auxiliary storage.

The multifunction peripheral 10 further includes a control panel 32, a scanner 36, and a printing engine 40 connected to the internal bus through their respective interfaces: a user interface 30, a scanner interface 34, and a printing engine interface 38.

The control panel 32 is operated by a user in front of the multifunction peripheral 10. The user can input various directions to the multifunction peripheral 10 from the control panel 32 and can change various preferences of the multifunction peripheral 10. The control panel 32 may be a touch panel having a liquid crystal display.

The scanner 36 is hardware that scans a document sheet on a document plate and produces image data of the document sheet. The image data is stored in, for example, the RAM 22 or the hard disk drive 26. The scanner 36 may have an automatic document feeder (ADF) that can automatically feed a plurality of document sheets onto the document plate one after another.

The printing engine 40 is hardware that prints on a printing medium, such as printing paper, according to print data. The print data may be produced in the multifunction peripheral 10 or transmitted from a remote computer 14.

Furthermore, a network interface 50, a fax interface 52, and a USB host interface 54 are connected to the internal bus of the multifunction peripheral 10. Thus, the multifunction peripheral 10 can be connected to the network 12 through the network interface 50, and connected to the fax network 16 through the fax interface 52. The multifunction peripheral 10 can also be connected to a USB device, such as a USB memory, through the USB host interface 54.

The scanner 36 produces image data and the printing engine 40 prints print data produced according to the image data. Thus, the multifunction peripheral 10 functions as a copy machine. Also, the multifunction peripheral 10 receives print data transmitted from a remote computer 14 through the network 12 and prints the print data with the printing engine 40. Thus, the multifunction peripheral 10 functions as a printer. Also, the multifunction peripheral 10 receives fax data transmitted from a remote facsimile through the fax network 16. The fax data is converted into print data and printed by the printing engine 40. Thus, the multifunction peripheral 10 functions as a fax receiver. Fax data produced according to image data produced by the scanner 36 is transmitted to a remote facsimile through the facsimile network 16. Thus, the multifunction peripheral 10 functions as a fax transmitter. In addition, the multifunction peripheral 10 acquires image data from a USB memory and prints print data produced according to the image data or the like with the printing engine 40. Thus, the multifunction peripheral 10 can function as a USB memory printer.

It will now be described how the multifunction peripheral 10 controls the precedence of jobs produced by user's panel operations and non-panel operations. As described above, panel operation means that a user in front of the multifunction peripheral 10 operates the control panel 32. In the present embodiment, the user can copy, scan and print, fax a document, and set preferences, from the control panel 32. On the other hand, jobs produced by non-panel operation (non-panel operation jobs) refer to jobs other than jobs produced by panel operation. In the present embodiment, non-panel operation jobs include host scanning, host printing, printing a received fax document, and printing a fax report.

The host scanning is a scanning manner in which a remote computer 14 directs the multifunction peripheral 10 with a document placed on the ADF or the document plate to start scanning through the network 12. The host printing is a printing manner in which print data produced by a remote computer 14 is transmitted to the multifunction peripheral 10 and the multifunction peripheral 10 prints the data. The received fax document printing is a printing manner in which the multifunction peripheral 10 prints fax data received through the fax network 16. The fax report printing is a printing manner in which the multifunction peripheral 10 prints a report to inform the user of whether the multifunction peripheral 10 has properly faxed a document to be faxed or has failed.

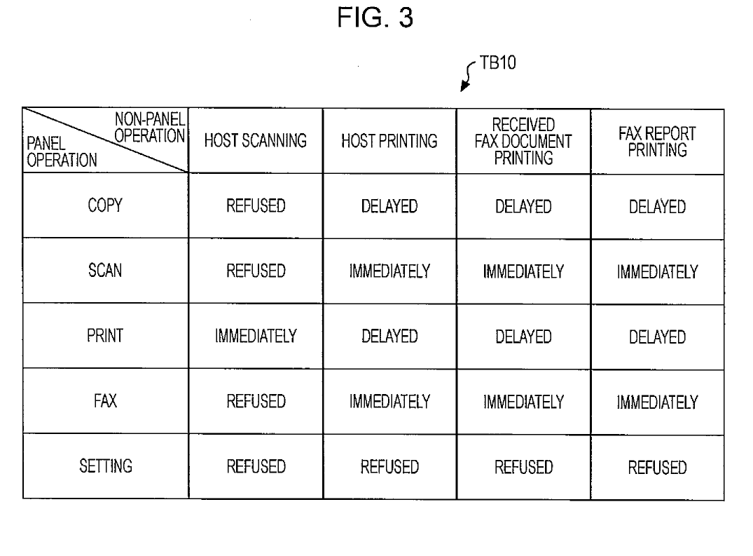

FIG. 3 is a job control table TB10 of the multifunction peripheral 10. The job control table TB10 may be stored and held in, for example, the ROM 24 or the hard disk drive 26 of the multifunction peripheral 10.

In the job control table TB10, the rows show the possible modes of the control panel and the columns show non-panel operation jobs the multifunction peripheral 10 receives. When the control panel 32 is in a copy mode, the user can set the number of copies and the scaling factor from the control panel 32. When the control panel 32 is in a scan mode, the user can set the resolution and select the color/monochrome option of the scanner 36 from the control panel 32.

When the control panel 32 is in a print mode, the user can set preferences from the control panel 32 for printing the image data stored in a USB memory or the print data stored in the hard disk drive 26, using the printing engine 40. When the control panel 32 is in a fax mode, the user can set the recipient fax number or the reading density from the control panel 32. When the control panel 32 is in a setting mode, the user can set preferences of the multifunction peripheral 10 from the control panel 32.

When the multifunction peripheral 10 receives a job of host scanning from a computer 14 while a user operates the control panel, the multifunction peripheral 10 returns the job of host scanning to the computer 14 if the control panel 32 is in the copy, scan, fax, or setting mode. On the other hand, if the control panel 32 is in the print mode, the multifunction peripheral 10 immediately executes the job of host scanning received from the computer 14. This is because the user uses the printing engine 40 while the job of host scanning uses the scanner 36, and, thus, a hardware resource conflict does not arise between the user and the non-panel operation.

When the multifunction peripheral 10 receives a job of host printing from a computer 14 while a user operates the control panel 32, the multifunction peripheral 10 automatically executes the job of host scanning after a lapse of an operation delay time T1 if the control panel 32 is in the copy or print mode. Thus, the operation delay time T1 has been set in the multifunction peripheral 10 to give priority to the convenience for user's panel operation. More specifically, non-panel operation jobs are not executed until an operation delay time T1 is elapsed after a user finally operates the control panel 32 and completes the job produced by the panel operation. The operation delay time T1 is set in the range of, for example, about 5 seconds to 3 minutes.

When the control panel 32 is in the copy or print mode, the user uses the printing engine 40 and the job of host printing also requires the use of the printing engine 40. Thus, a hardware resource conflict arises between the user's panel operation and the non-panel operation job. Accordingly, user's panel operation is controlled so as to precede the job of host printing, and the host printing job is placed in a queue. Then, the host printing job is automatically executed after a lapse of an operation delay time T1.

On the other hand, when the multifunction peripheral 10 receives the host printing job from the computer 14 during user's panel operation, and if the control panel 32 is in the scan or fax mode, the multifunction peripheral 10 immediately executes the host printing job. This is because the user uses the scanner 36 while the host scanning job requires the use of the printing engine 40, and, thus, a hardware resource conflict does not arise.

When the multifunction peripheral 10 receives a job of received fax document printing or fax report printing while a user operates the control panel 32, the multifunction peripheral 10 runs in the same manner as in the case of receiving the job of host printing.

If the control panel 32 is in the setting mode, the multifunction peripheral 10 refuses any job regardless of the type of job. This is because if the user changes preferences of the multifunction peripheral 10 in the setting mode, the change may affect all jobs.

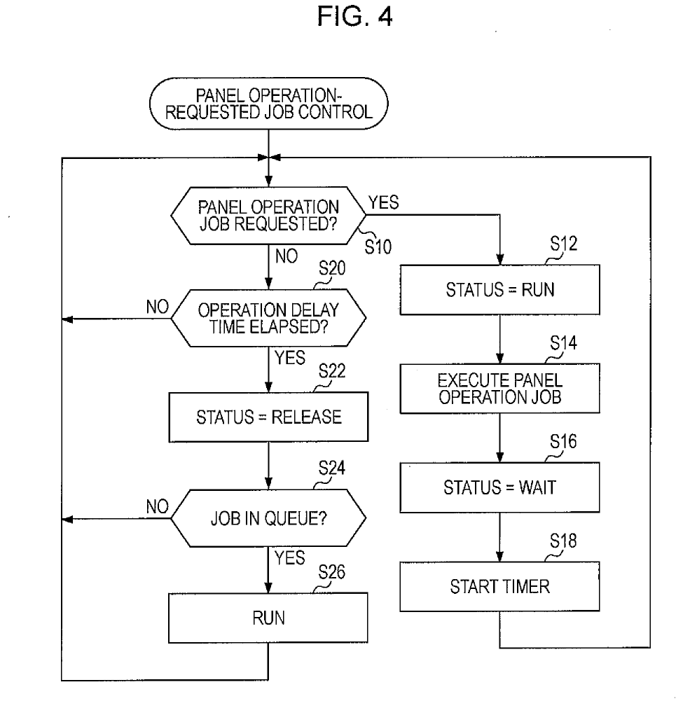

Turning now to FIG. 4, how the multifunction peripheral 10 controls jobs requested by panel operations will be described below. The control of panel operation-requested jobs is performed by reading a panel operation-requested job control program stored in, for example, the ROM 24 or the hard disk drive 26 into the CPU 20. The control of jobs requested by panel operations is constantly performed after the multifunction peripheral 10 starts operating.

As shown in FIG. 4, the multifunction peripheral 10 first determines whether or not a job has been requested by panel operation (Step S10). If a job has been requested by panel operation (if YES in Step S10), the multifunction peripheral 10 changes the status into RUN (Step S12). The status refers to information for the multifunction peripheral 10 controlling the precedence between the execution of non-panel operation jobs and the panel operations including the execution of panel operation jobs, and is temporarily stored in, for example, RAM 22.

The multifunction peripheral 10 subsequently executes the panel operation job (Step S14). If, for example, a copy job has been requested by panel operation, the multifunction peripheral 10 makes a copy; if a scan job has been requested by panel operation, the multifunction peripheral 10 scans.

After the completion of the panel operation job, the multifunction peripheral 10 changes the status into WAIT (Step S16). Subsequently, the multifunction peripheral 10 resets the timer to zero and starts the timer (Step 818). Then, the multifunction peripheral 10 returns to Step S10.

If no job has been requested by panel operation in Step S10 (if NO in Step S10), the multifunction peripheral 10 determines whether or not a predetermined operation delay time T1 has elapsed (Step S20). The determination whether or not the operation delay time T1 has been elapsed is performed with the timer started at Step 18. If the operation delay time T1 is set to, for example, 30 seconds and 30 seconds have elapsed since the timer started, the multifunction peripheral 10 determines that the operation delay time T1 has elapsed. In this instance, if the user operates the control panel 32, the value of the timer is reset to zero and the timer is restarted. Thus, the multifunction peripheral 10 prevents inconvenience to the user of executing a non-panel operation job during user's panel operation.

If in Step S20, it is determined that the operation delay time T1 has not elapsed yet (if NO in Step S20), the multifunction peripheral 10 returns to Step S50. If the operation delay time T1 has elapsed (if YES in Step S20), the multifunction peripheral 10 changes the status into RELEASE (Step S22).

Then, the multifunction peripheral 10 determines whether or not a job is in a print queue (Step S24). If there is no job in print queue (if NO in Step S24), the multifunction peripheral 10 returns to Step S10. If there is a job in the print queue (if YES in Step S24), the multifunction peripheral 10 extracts the job from the print queue and executes the job (Step S26). Then, the multifunction peripheral 10 returns to Step S10. If a plurality of jobs are placed in the print queue, the sequence of Step S10 and Steps S20 to S26 is repeated several times to execute the jobs one after another.

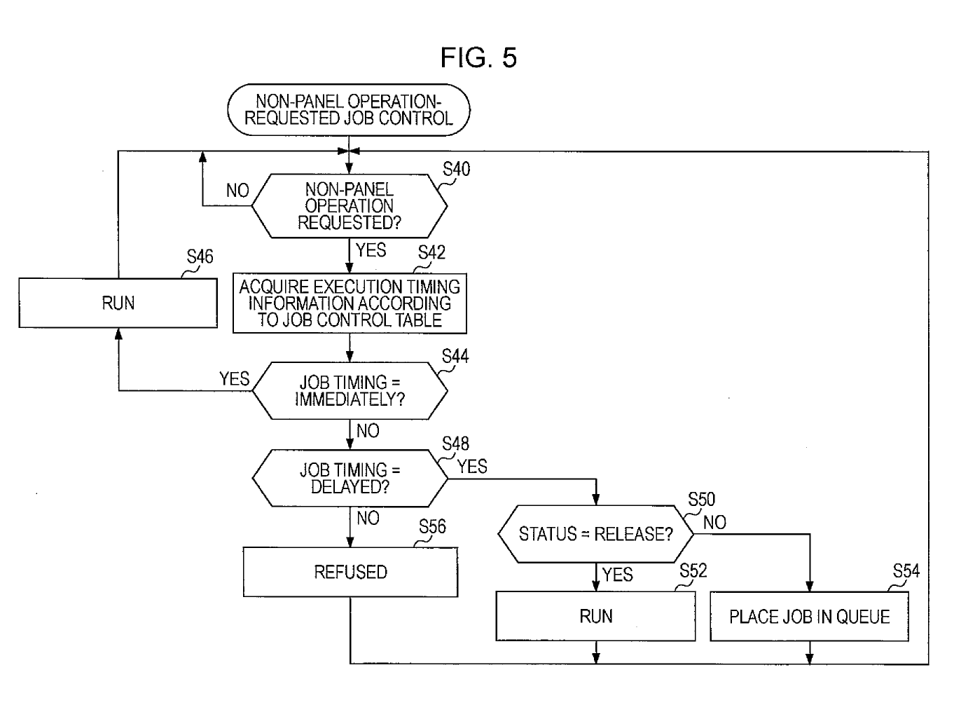

Turning now to FIG. 5, how the multifunction peripheral 10 controls jobs requested by non-panel operations will be described below. The control of non-panel operation-requested jobs is performed by reading a non-panel operation-requested control program stored in, for example, the ROM 24 or the hard disk drive 26 into the CPU 20. The non-panel operation-requested job control is constantly performed after the multifunction peripheral 10 starts operating.

As shown in FIG. 5, the multifunction peripheral 10 first determines whether or not a job has been requested by a non-panel operation (Step S40). If no job has been requested by non-panel operation (if NO in Step S40), the multifunction peripheral 10 repeats Step S40 to wait for a job request.

If a job has been requested by non-panel operation (if YES in Step S40), the multifunction peripheral 10 acquires timing information for executing the job according to the job control table TB10 shown in FIG. 3 (Step S42). More specifically, if the control panel 32 is operated, the mode of the control panel and the non-panel panel operation-requested job are identified. Then, execution timing information is selected from “immediately”, “delayed”, and “refused” according to the mode of the panel operation and the type of non-panel operation job. If the control panel is not operated, “immediately” is automatically acquired as the execution timing.

Then, the multifunction peripheral 10 determines whether or not the execution timing information acquired in Step S42 is “immediately” (Step S44). If the execution timing is “immediately” (if YES in Step S44), the non-panel operation-requested job runs (Step S46). Then, the multifunction peripheral 10 returns to Step S40.

If the execution timing information acquired in Step S42 is not “immediately” (if NO in Step S44), the multifunction peripheral 10 determines whether or not the execution timing information is “delayed” (Step S48). If the execution timing is “delayed (if YES in Step S48), the multifunction peripheral 10 determines whether or not the status is RELEASE (Step S50).

If the status is RELEASE (If YES in Step S50), which means that the operation delay time T1 has elapsed, the multifunction peripheral 10 executes the non-panel operation-requested job (Step S52). Then, the multifunction peripheral 10 returns to Step S40.

If the status is not RELEASE (If NO in Step S50), which means that the operation delay time T1 has not elapsed yet, the multifunction peripheral 10 places the non-panel operation-requested job into a queue (Step S54). Then, the multifunction peripheral 10 returns to Step S40.

If the non-panel operation job has been produced in a computer 14, the computer 14 may show a message that the job will run automatically after a while for the user during performing Step S54. For example, the computer 14 shows a message “wait for a while, and the requested job will run immediately after the completion of the current job” on the display.

If in Step S48, it is determined that the execution timing is not “delayed” (if NO in Step S48), which means that the execution timing is “refused”, the multifunction peripheral 10 refuses the non-panel operation-requested job (Step S56). Then, the multifunction peripheral 10 returns to Step S40.

If the non-panel operation-requested job has been produced in a computer 14, the computer 14 may show a message that the user should direct the multifunction peripheral 10 to execute the job after a while for the user during performing Step S54. For example, the computer 14 shows a message “another job is running, and try again after a while” on the display.

As described above, the multifunction peripheral 10 of the present embodiment gives precedence priority to user's panel operation using the control panel 32, and, in addition, immediately executes non-panel operation jobs as long as a hardware resource conflict does not arise. Thus, both the conveniences of the user operating the control panel 32 and the user producing non-panel operation jobs can be enhanced.

If the multifunction peripheral 10 immediately executes a job requested by a computer 14, such as host scanning or host printing, while a panel operation takes more time than expected, the ease of control panel operation is degraded and the multifunction peripheral 10 cannot execute the job produced by the user operating the control panel 32. In the multifunction peripheral 10 of the present embodiment, however, non-panel operation jobs are refused or executed after a lapse of an operation delay time T1 in principle during a period of time in which a user may operate the control panel 32. Thus, the stress of the user operating the control panel 32 of the multifunction peripheral 10 can be reduced.

Some of the non-panel operation jobs may not conflict with panel operation jobs for the same hardware resource, depending on the mode of the control panel 32 operated by the user. Accordingly, the multifunction peripheral 10 of the present embodiment determines whether a hardware resource conflict arises according to the mode of the control panel 32 and the type of received job. If a hardware resource conflict does not arise, non-panel operation jobs are immediately executed even if operation delay time T1 has not elapsed. Consequently, the user that has produced a job by a non-panel operation does not need to wait for a long time. Thus, stress of the user can be reduced.

### Second Embodiment

In a second embodiment, the scanner 32 of the multifunction peripheral 10 of the first embodiment is provided with an automatic multi-document feeder on which a plurality of documents can be set. When the automatic multi-document feeder is provided, even if a job of host scanning is produced by a non-panel operation, the host scanning job starts automatically after a lapse of an operation delay time T1. Different points between the first embodiment and the second embodiment will be described below.

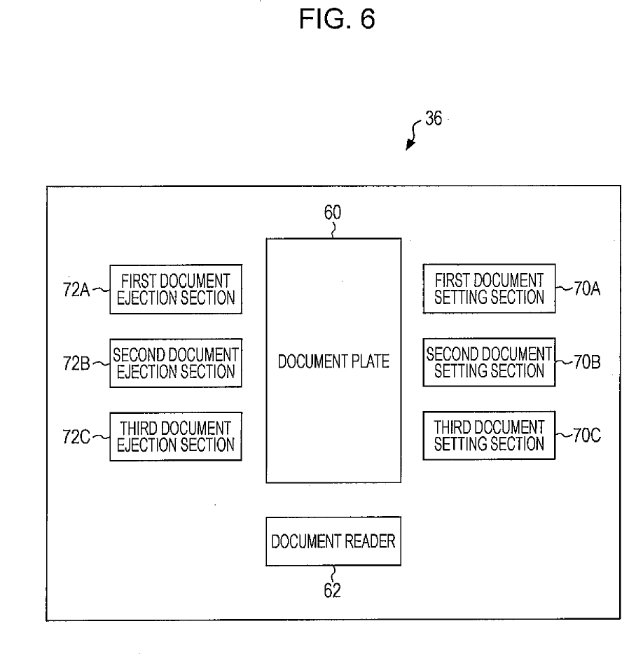

FIG. 6 is a block diagram of the internal structure of a scanner 36 of the multifunction peripheral 10 according to the second embodiment. As shown in FIG. 6, the scanner 36 includes a document plate 60 on which a document sheet is placed and a document reader 62 that converts information obtained by scanning the document sheet on the document plate 60 into electric signals and reads the signals to produce image data.

The scanner 36 also includes a first document setting section 70A automatically feeding document sheets to the document plate 60 one after another and a first document ejection section 72A to which the document sheets are ejected from the document plate 60 after the document sheets are read on the document plate 60. Furthermore, a second document setting section 70B and document ejection section 72B and a third document setting section 70C and document ejection section 72C are provided in the same manner as the first document setting section 70A and document ejection section 72A.

Hence, three documents can be set on the automatic multi-document feeder of the scanner 36. Therefore, the user can set a document on the second document setting section 70B even if, for example, the first document setting section 70A and the first document ejection section 72A are used for another document. On completing the automatic feeding of the document placed on the first document setting section 70A, the multifunction peripheral 10 starts automatically feeding the document on the second document setting section 70B.

Although the number of documents set on the automatic multi-document feeder shown in FIG. 6 is three, this number can arbitrarily be designed.

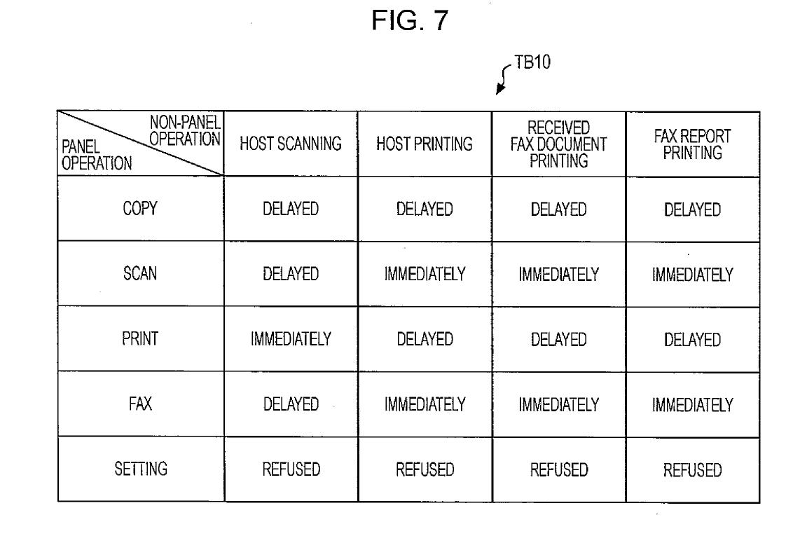

FIG. 7 shows a job control table TB10 used in the present embodiment. The configuration and function of the job control table TB10 shown in FIG. 7 are the same as those used in the first embodiment in principle except for the case in which panel operation and host scanning conflict with each other.

More specifically, when the multifunction peripheral 10 receives a job of host printing from a computer 14 while a user operates the control panel 32, the multifunction peripheral 10 automatically execute the job of host printing after a lapse of an operation delay time T1 if the control panel 32 is in the copy, scan or fax mode. For example, the user of the computer 14 places a document on an empty document setting section of the three document setting sections 70A, 70B, and 70C and directs the multifunction peripheral 10 from the computer 14 to scan the document.

The multifunction peripheral 10 that has received the host scanning job gives precedence to panel operation and places the host scanning job in a queue so as not to execute until an operation delay time T1 has elapsed, because the user operating the control panel 32 may use the scanner 36 for copy, scan, or fax. After a lapse of an operation delay time T1, the multifunction peripheral 10 executes the host scanning job.

For example, when a user operates the control panel 32 to copy a document placed on the first document setting section 70A, another user of a computer 14 places a document on the second document setting section 70B and requests a job of host scanning from the computer 14 to the multifunction peripheral 10. On inputting a direction to start copying from the control panel 32 after completing user's panel operation for copying, the multifunction peripheral 10 copies the document on the first document setting section 70A. After completion of copying and a lapse of an operation delay time T1, the multifunction peripheral 10 automatically starts host scanning of the document on the second document setting section 70B.

The panel operation-requested job control and non-panel operation-requested job control for the above control are the same as shown in FIGS. 4 and 5 in the first embodiment, respectively, except for using the job control table TB10 shown in FIG. 7 in Step S42.

While the user of the computer 14 is requesting the job of host scanning, the multifunction peripheral 10 does not refuse the host scanning job, but automatically executes after a whole even if the control panel 32 of the multifunction peripheral 10 is in the copy, scan, or fax mode. Thus, the convenience of the computer 14 user can be enhanced.

### Third Embodiment

In the second embodiment, when the user operates the control panel 32 in the fax mode, the multifunction peripheral 10 assumes that the user performs settings for faxing a document, and controls panel operation jobs and non-panel operation jobs. In a third embodiment, the multifunction peripheral 10 determines whether the control panel 32 operated by a user is in a fax read mode or in a fax print mode, and then controls panel operation jobs and non-panel operation jobs according to the determination. Different points between the second embodiment and the third embodiment will be described below.

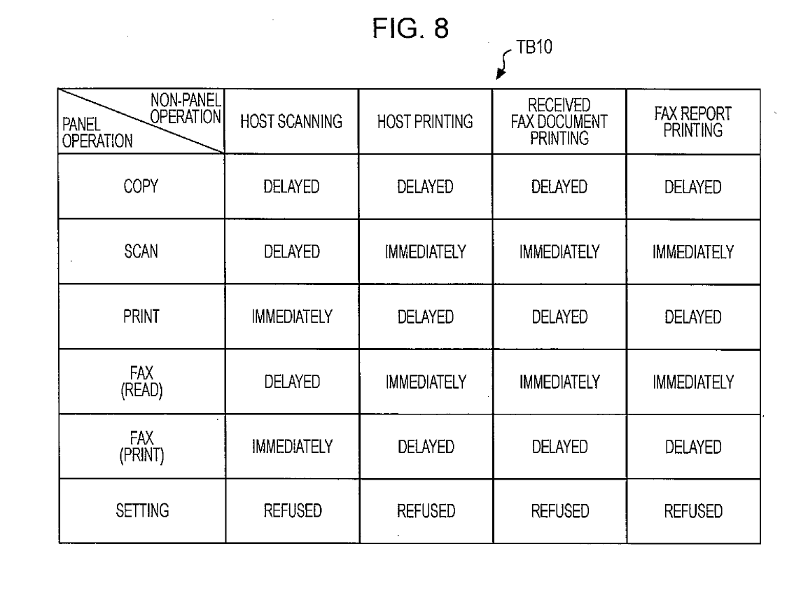

FIG. 8 shows a job control table TB10 used in the present embodiment. As shown in FIG. 8, in the job control table TB10 used in the present embodiment, the fax mode is divided into a fax read mode and a fax print mode.

In the fax read mode, for example, the user inputs a recipient fax number or sets the reading density from the control panel 32. In the fax print mode, on the other hand, the user searches fax data stored in the hard disk drive 26 from the control panel 32 in order to reprint a document received before or in order to print a document faxed before.

When the control panel is operated in the fax read mode, a non-panel operation job of host scanning is automatically executed after a lapse of an operation delay time T1, and non-panel operation jobs of host printing, received fax document printing, and fax report printing are immediately executed, as in the second embodiment.

When the control panel is operated in the fax print mode, unlike the second embodiment, a non-panel operation job of host scanning is immediately executed, and non-panel operation jobs of host printing, received fax document printing, and fax report printing are automatically executed after a lapse of an operation delay time T1. This is because the fax print mode causes a conflict for use of the printing engine 40 as the hardware resource.

By controlling the precedence of jobs as described above, the user of the computer 14 can immediately perform host scanning and also perform host printing after waiting only for a while even if a user operates the control panel 32 in the fax mode. Furthermore, the received fax document or fax report is automatically printed after a while without stressing the user operating the control panel 32.

While the invention has been described with reference to the above-described embodiments, it is to be understood that the invention is not limited to the exemplary embodiments, and various modification may be made without departing from the scope of the invention. For example, while the above embodiments use the multifunction peripheral 10 as a job processer, the invention may be applied to other types of job processer.

In addition, a program embodying the control of panel operation-requested jobs and non-panel operation-requested jobs may be distributed in a form of recording medium, such as flexible disk, CD-ROM (compact disc-read only memory), ROM, or memory card. In this instance, the above-describe job control can be performed by reading the program written in the recording medium into the multifunction peripheral 10 or other job processing apparatus and executing the program.

The job processing apparatus, such as the multifunction peripheral 10, may contain an operating system or other application programs. In order to use such programs in the job processing apparatus, a program including a command for calling a program running in the same manner as in the above embodiments from the programs contained in the job processing apparatus may be written in a recording medium.

Furthermore, such programs may be distributed in a form of transmitted waves through a network without using a recording medium. The program transmitted through a network is taken into a job processing apparatus, such as the multifunction peripheral 10, and the job processing apparatus executes the program to embody the above-described control.

The program may be encoded or compressed to be written into a recording medium or to be transmitted through a network. In this instance, the program read into the job processing apparatus, such as the multifunction peripheral 10, is decoded or expanded before being executed.

Although the controls of panel operation-requested jobs and non-panel operation-requested jobs are performed by software in the above-describe embodiments, hardware, such as ASIC (application specific IC), may perform the controls. In addition, the controls may be performed by cooperation between software and hardware.

The entire disclosure of Japanese Patent Application No. 2008-033112, filed Feb. 14, 2007 is expressly incorporated by reference herein.

What is claimed is:

1. A job processing apparatus comprising:
a first job-receiving section that receives a panel operation job produced by operating a control panel in a mode;
a second job-receiving section that receives a non-panel operation jobs other than the panel operation job;
a control panel mode-identifying section that identifies which mode the control panel is in when the second job-receiving section receives any one of the non-panel operation jobs;
a non-panel operation job-identifying section that identifies which non-panel operation job has been received by the second job-receiving section; and
an execution timing control section that controls when the non-panel operation job received by the second job-receiving section is executed, according to the identified non-panel operation job and the identified mode of the control panel.

2. The job processing apparatus according to claim 1, further comprising at least one hardware resource used for executing the panel operation job and the non-panel operation jobs, wherein if the identified non-panel operation job does not conflict with the identified mode of the control panel for the same hardware resource, the execution timing control section controls the received non-panel operation job so as to be executed immediately.

3. The job processing apparatus according to claim 1, further comprising at least one hardware resource used for executing the panel operation job and the non-panel operation jobs, wherein if the identified non-panel operation job conflicts with the identified mode of the control panel for the same hardware resource, the execution timing control section controls the received non-panel operation job so as not to be executed until a predetermined operation delay time elapses after the completion of the panel operation.

4. The job processing apparatus according to claim 3, wherein the execution timing control section places the non-panel operation job conflicting for the same hardware resource into a queue and executes the job placed in the queue after a lapse of the predetermined operation delay time.

5. The job processing apparatus according to claim 3, wherein the execution timing control section refuses to execute the non-panel operation job conflicting for the same hardware resource.

6. The job processing apparatus according to claim 3, wherein the hardware resource includes a scanner, and wherein if the identified non-panel operation job and the identified mode of the control panel conflict with each other for the scanner, the execution timing control section refuses to execute the non-panel operation job conflicting for the scanner.

7. The job processing apparatus according to claim 3, wherein the hardware resource includes a printing engine, and wherein if the identified non-panel operation job and the identified mode of the control panel conflict with each other for the printing engine, the execution timing control section places the non-panel operation job conflicting for the printing engine into a queue and executes the job placed in the queue after a lapse of the predetermined operation delay time.

8. The job processing apparatus according to claim 3, wherein the hardware resource includes a scanner that includes a document plate and a plurality of automatic document feeders, each automatically feeding a document onto the document plate, and wherein if the identified non-panel operation job and the identified mode of the control panel conflict with each other for the scanner, the execution timing control section places the non-panel operation job conflicting for the scanner into a queue and executes the job placed in the queue after a lapse of the predetermined operation delay time.

9. A method for controlling a job processing apparatus, comprising:
receiving a panel operation job produced by operating a control panel;
receiving a non-panel operation job produced by non-panel operations other than the panel operation job;
identifying which mode the control panel is in when any one of the non-panel operation jobs is received;
identifying which non-panel operation job has been received; and
controlling when the received non-panel operation job is executed, according to the identified non-panel operation job and the identified mode of the control panel.
